(19) United States
(12) Patent Application Publication
(10) Pub. No.: US 2010/0305959 A1
(43) Pub. Date: Dec. 2, 2010

(54) System and method for providing a media content exchange

(76) Inventors: J. Mitchell Johnson, Forth Worth, TX (US); Yury A. Bukhshtab, Moscow (RU)

Correspondence Address: Civins Denko Coburn & Lauff LLP, 816 Congress Suite 1205, Austin, TX, 78701, US

(21) Appl. No.: 12/804,881

(22) Filed: Jul. 30, 2010

Related U.S. Application Data
(63) Continuation of application No. 11/520,267, filed on Sep. 13, 2006, now abandoned.
(60) Provisional application No. 60/717,972, filed on Sep. 16, 2005.

(51) Int. Cl. G06F 15/16; G06F 17/30; G06Q 30/00

(52) U.S. Cl. 705/1.1; 709/231; 707/741; 707/E17.002

(57) ABSTRACT

A system and tool set provide a media exchange environment which facilitates motion picture, still photo and audio usage by allowing the editing and playing of streaming media presentations from potentially several remote libraries. A combined multimedia presentation is then streamed to a user. The system also supports media rights management, and represents what permissions the user must obtain in connection with a contemplated multimedia presentation.

### CROSS-REFERENCE TO RELATED APPLICATIONS

This application is a continuation of U.S. patent application Ser. No. 11/520,267 filed Sep. 13, 2006 which application claims priority to prior U.S. Provisional Patent Application Ser. No. 60/717,972 filed Sep. 16, 2005 in the names of J. Mitchell Johnson and Yury A. Bukhshtab, entitled “System And Method For Generating, Editing And Distributing Streaming Media.”

### FIELD OF THE INVENTION

The present invention relates generally to the field of multimedia programming, and more particularly to generating, editing and distributing streaming media.

### BACKGROUND OF THE INVENTION

Over the past 150 years, photography, audio recordings, and motion pictures have documented some of the most important people, events and other phenomena of world history. Having access to these materials provides an important and unique resource for the end-user.

In an increasingly “media-rich” world, however, it is still very much the case that the most useful and interesting audio-visual resources—films, video/audio tapes, and photographs (collectively referred to as “Media Objects”)—are inaccessible by users, whether students, teachers, professionals, or the general public. In many modern schools, certain Media Object access is only possible by means of video tape, film, or closed-circuit television, or actual visits to the physical locations such as archives, museums, etc. In most cases, however, the system is complicated, expensive, and incomplete. Developing countries, on the other hand, have little access to audio-visual materials, and, in any case, do not have the financial means to acquire them.

With the advent of the Internet and high-speed broadband Web connection, the technical capability now exists to bring Media Objects to computers in home, school and business environments. Digitization and storage of large numbers of Media Objects has become increasingly cost-effective and a new industry has developed called the Digital Asset Management (DAM) Industry. Technology is increasingly available which allows for Media Object playback and editing on the Web. In most case, however, Media Object rights-holders are unwilling to allow users free access to their Media Objects. On the other hand, most Media Object users are not willing or able to pay industry rates for Media Object use. The need therefore exists for a new technology that bridges this gap, and which (1) allow sponsored (like conventional free TV) and specific use of Media Objects, and (2) prevent their theft.

Companies like Real Networks, Apple Computer and Microsoft have addressed part of the problem with the development of a technology that allows “streaming” of video and audio whereby Media Objects are not downloaded but “broadcast” over the Internet in a manner which encourages “viewing” but in essence disallows a user from manipulating these images. While this is technology is fine for distribution of finished programs, it is not acceptable for situations whereby users need and want to manipulate or edit the Media Objects and/or create new programs for playback anytime, anywhere.

The invention comprises software tools for providing a multi-lingual collaborative environment, facilitating motion picture, still photo and audio (together, “Media Object”) usage. In a preferred embodiment, the invention supports education, sharing of cultural resources, Media Object licensing, media management, communication and entertainment.

In one embodiment, the system incorporates a system and technology which encourages the creation of new financial and business models and which can be developed by owner/licensors/consolidators of Media Objects such as that proposed by the Russian Archives Online (RAO) project (see www.russianarchives.com), the University of Texas' Knowledge Gateway (http://gateway.utexas.edu/), the Library of Congress' Collections (www.Loc.gov), and scores of other portals which intend to present to the world substantial Media Object collections. Using the Media Object usage reporting system, portal owners can measure and report what films and photos are viewed and for how long. This information can then be translated into detailed reports for sponsors who will pay for the opportunity to associate their messages with actual and measured viewing activity. This technology also allows Media Object owners to be paid royalties from this pay as you go sponsorship revenue stream (much like the ASCAP/BMI system developed for conventional radio stations). A user can thus search archives, museums, and other Media Object owners' archives, and then allow them to edit and utilize the found Media Objects in their classrooms, presentations, and other communications. It carries out the licensing procedures for them, sets up payments, discounts, or any other e-commerce arrangements to be made.

### BRIEF SUMMARY OF THE INVENTION

The above summary of the invention is not intended to represent each embodiment or every aspect of the present invention. Although various embodiments of the method and apparatus of the present invention have been illustrated in the accompanying Drawings and described in the Detailed Description, it will be understood that the invention is not limited to the embodiments disclosed, but is capable of numerous rearrangements, modifications and substitutions without departing from the spirit of the invention as set forth herein.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a schematic diagram of a media editing and streaming playback system in accordance with the present invention;

FIG. 2 is a schematic diagram in accordance with FIG. 1, and further showing a local media storage device.

FIG. 3 is a schematic diagram in accordance with FIG. 1, and further representing subsystems for uploading digital media to the system.

### DETAILED DESCRIPTION OF A PREFERRED EMBODIMENT OF THE INVENTION

By using the preferred embodiment of the present invention, a novel system and method is provided. In the preferred embodiment of the invention, a software system and tool set provide a multi-lingual collaborative environment which not only facilitates motion picture, still photo and audio (Media Object) usage, but also supports education, sharing of cultural resources, Media Object licensing, media management, communication and entertainment.

The system and method of the present invention may, in preferred embodiments, incorporate:

Customizable User Interface—Allows the User to set-up the system according to his or her own business, pedagogical, language, or other needs.

Search/Retrieve—An “Advanced Multimedia Search and Deployment” system which allows Users to efficiently search WAO and other participating media object repositories world-wide and instantly obtain the necessary media objects for editing or playback. This will consist of a combination of technologies: (1) a multiple-use text-based search engine based on text indices, meta information associated with images and sounds and aligned with the recently released NISO (National Information Standards Organization) Framework of Guidance for Building Good Digital Collections; (2) a “content search” technology that uses “visual primitives” (Image characteristics that can be determined automatically by digitized visual data). This content search feature allows for searching by description of object shape or color; (3) an auto key frame capture and display tool will also be offered that can analyze a motion picture and automatically find and display representative frames from each disparate scene. This function is very helpful for gaining a quick understanding of the content of a motion picture.

Player—such as the Real Networks® player (open source).

Editor—A tool that handles both still images and/or streaming video and audio files. This system provides a wide array of fast and easy-to-use online digital, non-linear editing functions, which allow manipulation of media objects. Still images can be cropped and enhanced with contrast or color correction. The editor will also feature facilities such as stop, per-frame preview, rewind, fast-forward, etc. The edited sequence can then be stored and retrieved via streaming technology on the Web.

Insertion of photos, images, pictures into projects—In addition to streaming video, the system supports a number of other visual formats. Users can insert images and similar objects (photos, pictures) into project files. The image could be pasted in at any point in the video or audio clip.

Store/Retrieve—A function which allows Users to store and then retrieve MIP's which have been created in the system. An upload media function allows (under specified e-commerce business conditions) Users to import and store media objects from outside the system which can then can be combined with the system media objects.

Licensing/Export/Import—Under specified conditions, Media Objects and/or completed MIP's can be downloaded for deployment outside the system using the automated content licensing system.

Measure & Report—An automated and combined “Digital Rights Management” (“DRM”) and media Usage Royalty Generation System that will allow the further compensation of owners of media objects (Owners) with royalty payments based on usage formulas—royalties can be derived from revenue generated from a select number of commercial sponsors.

The system provides a new or enhanced revenue for many content owners. Owners will receive royalties based upon usage. The content owner can receive a share of all sponsorship and/or sales revenues collected from the viewing of their material based on specific agreements with content owners whereby they might receive a certain percentage of sponsorship revenue gained by the viewing of their content.

Meta-data & Media File Exchanger, a user customization tool set which allows the possibility to customize the system for use in a proprietary “Local Area Network” (“LAN”) environment, and/or other settings. This is essentially a spin-off software product that (1) allows archives everywhere to use the system tool set; (2) automatically accommodates an archive with different meta-data standards than the system's, and (3) customizes the level of media content exchange with the system's global system.

The editor of the present invention thus makes available to users advanced video and sound editing features without the requirement of the downloading Media Objects or installing traditional media editing software. Owners and licensors of Media Objects can post their Media Objects on the Web and enable their specific, secure and advanced use.

Playlist Editor—Playlists can be created using RAM files rather than SMIL files as used for Projects. Therefore, this is not only a new feature but a new technological base. The Playlist Editor supports films, projects, pictures, and music fragments.

The Playlist Editor supports the following:
Create playlist
Add items to playlist
View an entire list or to begin viewing from any individual component in the playlist
Re-order components in the playlist
Delete components in the playlist
Edit components in the playlist
Save the playlist
   Video clips are presented in the playlist Editor as freeze-frames. Playlists allow the use clips via HTTP protocol as well as RTSP. As a result the Playlist is not only a tool for viewing different clips in any order but as well a new interface that supports in-place editing within the Media Editor.

Accordingly, the present invention effectively allows a new financial and business model which for /licensors/consolidators of Media Objects such as Russian Archives Online (RAO) project (http://www.russianarchives.com), the University of Texas' Knowledge Gateway (http://gateway.utexas.edu/), the Library of Congress' Collections (www.Loc.gov/), and scores of other portals which intend to present to the world substantial Media Object collections. Using the Media Object usage reporting system, portal owners can review reports about which films and photos are viewed and for how long. This information can then be translated into detailed reports for sponsors who will pay for the opportunity to associate their messages with actual and measured viewing activity. This technology also allows Media Object owners to be paid royalties from this pay as you go sponsorship revenue stream (much like the ASCAP/BMI system developed for conventional radio stations).

Besides the revolutionary technical break-through in the area of editing “streaming video files” and measured media usage, the present invention offers significant enhancements to the more traditional problems of informatics—finding the best methods of organizing and managing Media Object data bases, and development and implementation of software needed for their analyzing, indexing, and searching.

The software system of the present invention can exist both as a stand-alone Web site and be designed for easy installation on Web portals which feature streamed Media Objects. In an alternative embodiment, users have the ability to reach out over the Web and strategically connect with relevant Media Objects sought by its users. Like the current RealNetwork's “Real Player” technology, users of a web site can be encouraged to freely download the software that offers the following features:

Basic & advanced search tools—A multiple-use text based Search Engine based on both indexation of texts and meta information associated with images and sounds, and a “content search” which uses “visual primitives” (image characteristics that can automatically be determined by digitized visual data); this allows for searching by the descriptions of object shape or color.

Auto key frame capture and display—A tool, which can analyze a motion picture and automatically find and display representative frames from each disparate scene. This function is very helpful for gaining a quick understanding of the content of a motion picture.

Media Player/Recorder/Editor—A tool, which handles both still images and/or streaming video and audio files. This system provides a wide array of fast and easy-to-use online digital, non-linear editing functions, which allow manipulation of Media Objects. It will also features facilities such as stop, per-frame preview, rewind, fast-forward, etc.; the edited sequence can be stored & retrieved via streaming technology on the Web.

Customizable User environments—A capability that allows users to create thematic sub-spaces (a set of different objects and attached procedures that are united by a common range of problems and that allow to provide a user or a group of users with full information support). Among other things, visitors will be presented with different user interface designed for their specific use (commercial or educational etc.), to create and store customized projects such as documentary films or learning modules.

The Database can store markers and sequencing information. This includes “nested folders” and “multiple project bins” within a single user account. This is related to the current implementation supporting access to both public and shared bins. Users can be associated into communities or other groups and can create common work using both their own and common media objects.

E-Commerce Task Manager—An E-commerce section that handles rights managements, contracts and payments, and image licensing order fulfillment support. A Media Object use measurement and reporting system may be included. This supports and facilitate transactions that involve a Media Object being downloaded or otherwise be exported out of the secure environment.

For example, the present invention can be adapted to allow students and teachers at every academic level and discipline to freely research, create, sort and exhibit their own multimedia presentations for school assignments. It allows the development and use of educational on-line courses and encyclopedias presented in the form of hypertexts with illustrations and audio and video clips.

An alternative embodiment includes film and TV productions. In the process of documentary film making, one of the most significant challenges is the selection of the needed items from film archives. Very often the necessary archive can be found only in another city or in another country. In this case members of the team that is making the film have to visit the archive, or at best, for them to be able to select the needed fragments they need to order on the basis of rough descriptions and viewing copies that are normally sent by mail.

Using an embodiment of the present invention, the film director on the Internet will search for the needed films in the archive database that contains textual descriptions of films and representative freeze frames. Then he will preview the selected film in the video-streaming mode without downloading all video files from the server, but by marking the needed fragments. A list of the needed video materials with the data of the original will be automatically created. Then this list after its processing by the E-commerce module will be directly used for placing an order for video clips of a professional quality level through the Internet.

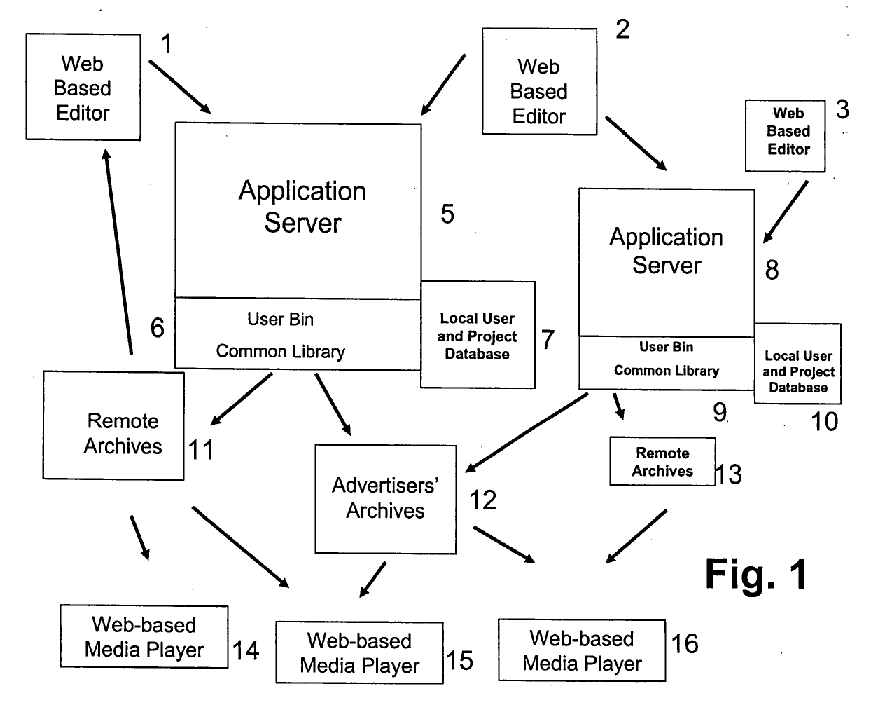

In reference to FIG. 1, a user accesses a browser 1, 2 and runs the application in editing mode to create new streaming content. The browser accesses application server 5, which stores local user and project information in database 7. A user common library 6 can also be stored at 5. The system connects remote archives with the editor and streams content for preview selection, and editing.

Application server 5 can access remote archive 11 and advertisers archive 12. Information can then be transmitted to media players 14, 15 and 16 in streaming format. In an alternative embodiment, a plurality of application servers with separate and potentially overlapping archives are used (see, e.g. 8, 9, 10 and 13).

Using the system, a content creator can publish new works to streaming media players on the Internet using a simple URL.

Each application server 5, 8 has a specific user and project database 7, 10. This is where user account and project clip references—but not media—are stored. User has access to content that is referenced through the local Common Library or User Bin 6, 9, both of which are virtual storage areas for specific clip edits.

The actual media is stored in streaming format, on either an associated local media server or on any number of remote media servers. The advertisers archive 12 is an example of an archive that is available to more than one application server installation. Web-based streaming media players—for example the Real Networks Media Player®—can be used to view streaming content. A single user can have independent access to more than one application server 5, 8.

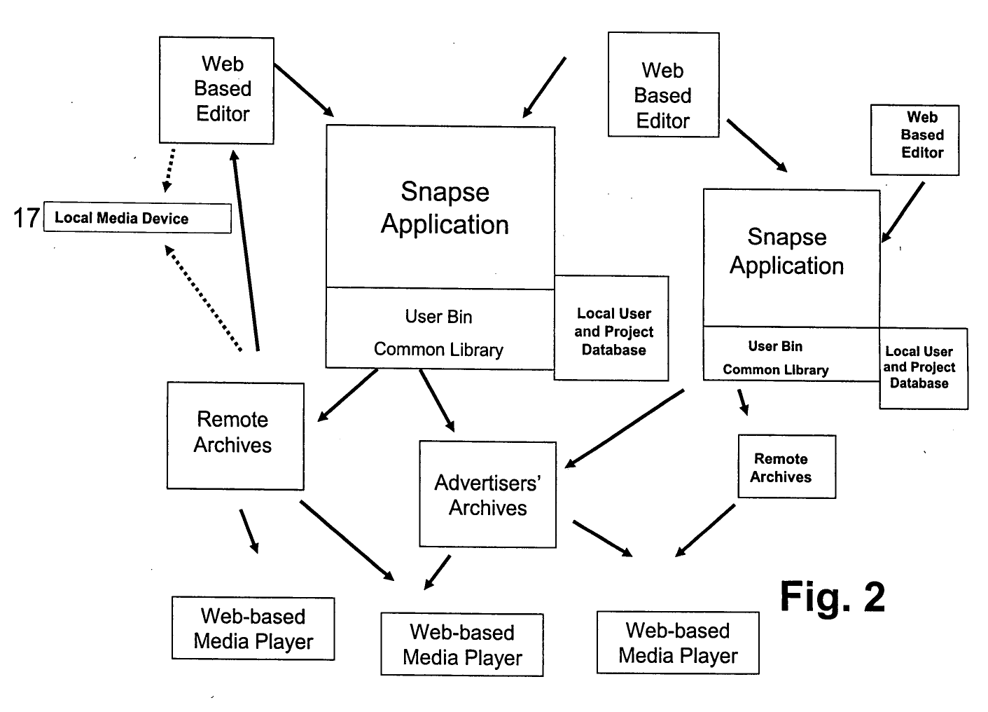

FIG. 2 shows that, in an alternative embodiment, licensed content can be downloaded to a local media device 17, for example after payment of a fee. In this instance, the media which is normally streamed from the application server is transmitted to a local media device. DRM may be used to monitor/preclude unlawful duplication once the data has been transferred.

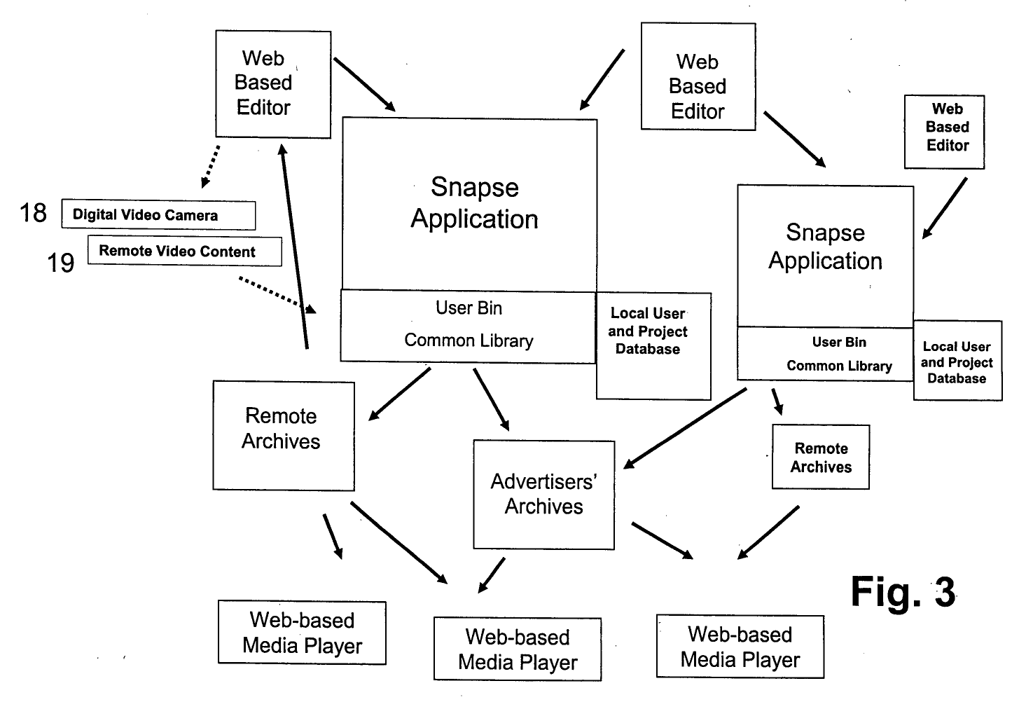

Turning to FIG. 3, content 19 may be uploaded by the user from local devices 18 to the remote application server and associated database. In this way, user-specific content may be stored remotely, and subsequently accessed by the user or those authorized by the user remotely. The user may thus utilize user-specific content in a combined streaming presentation with components from other digital libraries. Moreover, in this way, convenient and potentially collaborative editing and playback may occur.

As suggested above, in a preferred embodiment, the present invention incorporates a “rights management” system that can facilitate the compensation of the owners of Media Objects with royalty payments based on actual usage reports. This function can support a new business model that can benefit Media Object right's holders (creates new royalty stream), Media Object users (get free and advanced access to media), and sponsors (pay only for actual impressions) alike.

The market presently offers a range of software products providing for some degree of streaming video editing, one of which is the RealMedia® Editor. However, these products are not intended for interactive work without downloading files.

A preferred embodiment of the invention thus includes the tools for the elaboration of an integrated software environment dynamically adjustable to the specific nature of the tasks to be solved. Such an environment provides for the interaction and information exchange between the applications intended for various-type data processing.

The system can be used with not only Real Media® but other streaming formats, including for example QuickTime® and Windows Media Player® format via RTSP and HTTP protocols.

The software component responsible for video and audio editing enables the user to paste, remove, cut and rearrange the video and audio pieces while editing. At the same time, the results of the user's work can be stored in the server database and, on its request; an appropriate video-clip will be generated and transmitted in the form of streaming video for browsing thereafter.

The program makes it possible to view video clips with the help of a modified RealPlayer window built into the interactive page. In this case a user has options such as stopping and resuming clip viewing, stepwise viewing (both forward and backward) with a selection of the step increment starting from 0,1 sec. (tests showed that positioning with such accuracy is possible), and changing the size of the RealPlayer window. Viewing control is accomplished by programs written in JavaScript, and installed at the user's computer (these programs interact with RealPlayer, and the latter afterwards turns to Helix-server). At the same time the user has a time code, which is a relative time measured from the beginning of the clip. Users can use the time code to mark the start and end of the clip segments that are of interest to him. These markings are then processed by a proper program and are transferred to the server. Information about the segments selected by the user is saved by the server (HTTP-server) in the database with the help of special CGI-programs. Adequate CGI-programs can also perform actions related to clips editing.

The system may include programs providing users with a possibility to combine segments from different clips in a required sequence to create a new clip. These programs can, e.g., generate SMIL files containing a description of the user's selected segments. Generated SMIL files are presented in the XML format. They assign information about clips that are played under their control, first information being the initial and final time codes of the selected segments. Clip sequence is also set up in SMIL files. Under SMIL file control, the system performs advance segment reading. In this way, switching from one clip to another is done without visible time delay. SMIL files enable segments from various clips to be recorded in different resolutions and at different speeds. Such segments can then be combined into one common clip, which in principle allows using segments from clips located in different servers by indicating in the SMIL file the appropriate URL-addresses of segments picked by the user. Thus, the implemented software model of the video editor allows the user to delete and pick up segments from the source clip, to add the selected segments to the end of a new clip, and/or to insert it in any part of the clip. User's actions related to editing the video data are transferred interactively to the server, by the required CGI-programs that edit SMIL file. The work result can be viewed immediately in the RealPlayer window. Thus, a clip developed by the user is presented only by SMIL file, and not by a Real video file.

Later this new clip created by the user can be utilized in the same way as the source clip. It is in-turn possible to select segments from it, as RealPlayer plays the clip assigned by the SMIL file as a common video document reading the time codes of the segment.

A specialized data base management system (DBMS) makes it possible for the users to work with catalogues on CDs without prior installation, and can function in the Internet while using servers on different platforms. The developed DBMS based on the B-tree structure allows localization of the necessary information in big data volumes within seconds. Search words for the system are the words that are met in the database entries, with an exception of those fields that are announced as fields that cannot be indexed, and the so-called stop-words, a modifiable list of which can be assigned for each application. Logical combinations of words that can be masked are used in queries. In this case a request may include names of the fields, which makes it possible to control a place in the record, where the search words are looked for. The search results are shown in the format that is suitable for fast selection of the most relevant information—in a list, where the found entry are presented in brief (for example, headings), and the entries themselves can be viewed in full in a special window with records. The DBMS has another convenient means of relevant information sampling—hypertext links that link the entry text to heterogeneous information related to the text—a picture, a video or audio clip, or a program that is external in relation to the DBMS. In order to fill the information collection of the target search systems built on the basis of the considered DBMS, a number of utilities has been developed, providing the possibility of using texts presented in different formats, including Microsoft Word documents and records in Microsoft Access. A specialized editor has also been developed, allowing the users to enter texts directly into the database, and modify them. This software system is written completely in C++, without any licensed software products.

As an illustrative example, all the products developed under the Russian Archives Online Project and a number of other archive projects apply DBMS and the results of its use have proved its effectiveness in solving the problems in the creation of various electronic catalogues. Four target information systems were created in three Russian State Archives (in particular, the database with descriptions of documentaries at Russian State Archives of Documentaries and Photos includes more than 40,000 entries, about 100 users per day are working with the database via Internet, and several dozen users are working with it via local network at the archives). This database is located at three servers (at Russian Archive Agency server, Moscow office of Internews and the Keldysh Institute), and at the Russian State Archive of Documentaries and Photos local network, the Russian State Archive for Scientific-Technical Documentation local network and the Russian State Literature and Art Archive local network. The experience of creation and operation of this DBMS was described in a number of articles and presented at different conferences and workshops, for example:
“Digital Library of Documentaries “Cinema Chronicle of Russia,” 8^{th} international conference “GRAPHICON,” Moscow, 1998;
“Digital Library of Documentary Video Materials,” Russian British Workshop “Digital Libraries,” Moscow, 1999;
“The main functions and the architecture of the information system for searching film documents,” East-West collaboration in the development of interactive media, Hungary, 2000.

An alternative embodiment includes a Content-based Visual Information Retrieval (CBVIR) system intended for organizing a large collection of digitized images and searching for video using content-based visual information retrieval. The basis of the CBVIR system is the ability to extract and index the visual content using visual features (color histograms, shape measures, texture measures, and motion characteristics) automatically. Queries can be based on using similarity measurement, which is defined as overall similarity made up of similarity measurements of all visual features.

Tools for visual features extraction and on designing comparison algorithms include:
Similarity measurement for still images based on color histograms computation and on their quantitative comparison (possibly using quadro-tree technique).
Edge detection using non-maximal suppression of the image intensity first spatial derivative. Spatial segmentation detects objects characterized by dominant color and by shape.
Shape measurements based on two functions computed for the contour—turn angles and centroid distance.
Texture measurements: we are exploring the Gabor functions method and the use of a gray level co-occurrence matrix.
Video temporal segmentation based on color histogram comparison for the consecutive video frames.

Video indexing technique: representative key frames extraction and using of visual features extraction methods developed for still images; and using additional optical flow parameters. [Please explain these statements, which seem fragmentary] The following procedures are useful in various situations: optical flow computation using differential technique; moving entities detection in video on the basis of the total optical flow analysis; characterizing each extracted object by its location, size and motion type; multilevel classification of video by motion type (in particular, the classification enables the detection of the specific camera functions, e.g., zoom); face detection in images using neural network.

It is a common practice to label the video with any form of structured text to identify the video content. However, this practice suffers from shortcomings. Such text descriptions cannot be obtained automatically with the current technologies. The documentaries can only be described by experts, the work is both tedious and subjective. The video content can't be expressed by words in one single way and, as a result, the traditional text oriented retrieval of relevant video data from the information stock is characterized by insufficient precision and recall.

The users of CBVIR systems recognize shortcomings with traditional query facilities on the basis of textual information associated with images. Enhanced functionality is provided to formulate non trivial queries on the content of video data in terms of visual attributes. Generally, content can be conveyed in both the narrative and the image. The textual content is commonly expressed by metadata. Text descriptions provide the important information not available from visual analysis. For example, given a typical urban view, it may be impossible define city's name. Also, searching by keywords is much faster than searching by visual content. The indexing of the words from metadata permits rapid retrieval of video segments that satisfy an arbitrary query on the basis of the narrative content. Any textual information attached is useful to quickly filter video segments containing potential items of interest.

Another issue is the technique for extracting visual content from video data. The essential problem is the vast size of video files. An acceptable approach is to segment a video stream into camera shots in which key frames are chosen that represent the progressively varying image content. Shot boundaries can be chosen by detecting transitions between scenes (such as fades, cuts, and dissolves). For this purpose, algorithms that effectively operate on compressed video stream were developed. Pixel-oriented methods of segmentation are used; frames with the most considerable image changes may be extracted from a frame sequence based on frames difference statistics. Once the shots are determined, the system extracts the representative frames from each shot. Then for each extracted frame visual characteristics are computed and indexed.

Client software for the selection of freeze frames from streaming clips—The editor allows the user to indicate the time interval when frames will be selected automatically from the video stream. The user can delete frames which are not acceptable as freeze frames. The frames selected by user are packed in the special file connected with the actual clip. The selected freeze frames are shown together with other information (metadata) connected with corresponding clip (film/project). The user can view the film from the point corresponding to the freeze frame. This is a convenient tool for searching through long films.

To solve the problem of video fragment boundaries detection, the invention may incorporate an algorithm based on the comparison of motion histograms corresponding to two neighboring frames. Testing of the modeling software was done with the use of videos from different sources with different quality. All videos were divided into groups and results within one group were similar. Below are average results showing the percentage of errors given by different methods of segmentation on different video groups.

False detections

| Method | (1) | (2) | (3) | (4) | (5) |
|---|---|---|---|---|---|
| Cartoon films | 10% | 10% | 31% | 18% | 0% |
| Color | 33% | 11% | 33% | 33% | 27% |
| video | | | | | |
| Black | 23% | — | 25% | — | 12% |
| & white video | | | | | |

Missed fragment boundaries

| Method | (1) | (2) | (3) | (4) | (5) |
|---|---|---|---|---|---|
| Cartoon films | 0% | 0% | 0% | 0% | 0% |
| Color | 0% | 0% | 0% | 0% | 0% |
| video | | | | | |
| Black | 3% | — | 2% | — | 10% |
| & white video | | | | | |

Various methods include: palette is divided according to intensity; palette is divided into RGB-parallelepipeds; quadrotree & palette are divided according to intensity; quadrotree & palette are divided into RGB-parallelepipeds; palette is divided according to intensity, more sophisticated distance formula and alignment of histogram is used. [Please explain]

(Errors percentage—number of errors divided to sum of errors and correctly detected boundaries, multiplied by 100%.). [Please explain]

Various research groups have already accumulated certain experience in implementing algorithms that afford automatic description of an image in terms of visual features. Taking into consideration their results our research group are exploring and developing visual features extraction and comparison methods. Considering the visual content of video images as compared with static images, it is necessary to take into account spatio-temporal semantics. We are implementing the computation of the motion features based on the video frame sequence, as well as algorithms determining characteristics of a static image (a frozen frame) related to color, shape, and texture.

As for color parameters, in parallel with implementing the method of color histograms, a program for detecting image regions containing certain color sets is being developed. This program is supposed to be used for extracting and indexing the prominent color regions. When applying to gray scale images this program extracts uniform regions by localizing the close gray values. The method ignores insignificant color information using a set of filters. The extracted region is approximated by the minimum color information contained in the rectangular region. Its size and location in an image are to be indexed as well as the represented colors.

The method of color region indexing is an example of local indexing. Generally, indexing is more precise if it is performed not on the entire image, but on parts of it. Therefore, spatial image segmentation or local region extraction is preferable.

The image segmentation is the first step of the shape measurement computation. To describe the shape of previously extracted contours bounding image objects, the Fourier transform of the contour curvature, and of the Fourier transform of the distance between the contour points and the center of the figure are used.

Two methods for texture are also provided. The first one is the method of Gabor functions that uses a set of energy values of the Gabor mask for various wave directions and lengths. The other method involves the use of characteristics of a gray level co occurrence matrix.

Motion-based features we used are related to the optical flow. The optical flow is the distribution of apparent velocities of movement of the brightness patterns in an image. The optical flow assigns to every point on the visual field a two-dimensional velocity at which it is moving across the visual field. We apply differential technique to compute velocity from the spatiotemporal derivatives of the image intensity function. Two methods are disclosed, though others may be know to those of skill in the art: the first one uses the Horn and Schunk (Massachusetts Institute of Technology) technique, the other method was proposed by Lukas and Kanade (Carnegie Mellon University).

In some cases, it is not sufficient to detect objects of a certain class. Thus, if the system is capable of detecting a person or, in the least, a human face in consecutive frames in a video stream, the next thing to do is to connect the object recognized to a certain person that appears in the text description of the video material. We believe that this may be done in a semiautomatic mode, based on the interpretation of the corresponding text descriptions. The idea of using text descriptions of video content for this purpose and, generally, for understanding the visual content appears to be promising. In some cases, it is possible to establish a correspondence relationship between words of the text—verbs expressing human actions—and their visual reflection in terms of pixels. Thus, one can define, for example, verbs of motion (the speed of the centroid of the object exceeds a threshold number of pixels per frame), verbs expressing spatio-temporal interaction (an object approaches another object, and is separated from it by a distance measured by a certain number of pixels), and some other verbs. If there are textual descriptions of video material, this information can be used for detection a person as well as for its automatic identification with a character from the description. For example, if it is stated that in the description that a person is coming towards another person, then the system may interpret this as one object approaching the other (spatio-temporal interaction), while the other is motionless.

Results of work in the area of development and implementation of the methods of analysis, indexing and searching images and video by visual attributes are published and reported at many international conferences, including the following, which are hereby incorporated by reference:
Methods of Searching Video Information. “Programming and Computer Software,” N 3, 1999.
Digital Library of Documentaries “Cinema Chronicle of Russia,” 10th DELOS Workshop on Audio-Visual Digital Libraries, Santorini, Greece, June 1999.
Structuring and Searching Video information, 1^{st} Russian conference “Digital Libraries,” St. Petersburg, 1999. Digital Library of Documentaries “Cinema Chronicle of Russia.”
Modern technology of content-based searching for electronic collections of images, Papers of the International Conference “Electronic Imaging & Visual Arts” (EVA 2000), Moscow, December 2000.
Methods of indexing and searching images and video data on the base of visual content, Second Russian Conference “Digital Libraries: perspective methods and technologies, electronic collections,” Protvino, Moscow region, September 2000.
Russian Archives Online Project (RAO): current situation and perspectives. Papers of the International Conference “Electronic Imaging & Visual Arts” (EVA 2001), Moscow, December 2001.

In an alternative embodiment, the system provides multi-language access to meta information. It must be noted that the use of media objects in the target systems in many cases do not require translation. This makes it somewhat easier to use such systems by users of the different language backgrounds. Nevertheless, within the framework of this project it is planned to provide access to meta information in a minimum of two language—English and Russian. The machine translation software is installed in the server, providing a translation of meta information in accordance with the users' requests, and they can receive the requested data in the language of the request. In 2002 a team of the project developers conducted a research in this field within the framework of a pilot project—translating from Russian to English the film descriptions in the Russian State Archive of Documentaries and Photos catalogue that was implemented on the basis of the above said DBMS (3,000 documents out of the available 40,000 were translated). Systran Professional was used as the software for machine translation. During the process, an additional dictionary particularly for the description of the subject area of documentary films was developed. Also, expert linguists developed the guide to help with the meta data creation, making it possible to achieve a higher level of machine translation. For example, using denominative sentences instead of non-verb sentences, using simple sentences (with verbs), not using syntactically complex texts with lots of participles and gerunds, not using abbreviations, and a cautious approach towards different numerals expressions, etc. The conducted experiments showed that following the developed recommendations considerably improves the quality level of the machine translation.

In order to further improve multi-lingual possibilities of the present invention, it may use a form of search patterns—situation frames. In comparison with simple sets of keywords, text information represented in frames is structured (definite roles are fixed for keywords on the basis of situation context). Therefore this kind of representation is more controlled and could be translated into different languages using special thesauri—this process is simpler than translation of the text in a free form.

To construct the query to information system, the user may use situation frames in one of the possible languages—the technique is be close to query-by-example (this approach corresponds to the extended concept of controlled vocabulary). Certainly the possibility of searching by key words (words, included in the search pattern) also could be used.

In a preferred embodiment, media may be united into a single system where it is easy to find and use by potential customers. Specific content use agreements may be developed with each type of content owners respectful of diverse needs, wants and ideas.

In a preferred embodiment, the system provides a new or enhanced revenue stream for many content owners. Owners will receive royalties based upon usage. A content owner can be provided a share of all sponsorship revenue collected from the viewing of their material. For example, an agreement might be reached with a content owner whereby they might receive a certain percentage of sponsorship revenue gained by the viewing of their content. Owners will also receive a percentage of all revenue gained from payments from users for content taken off.

In one embodiment, every content owner will be provided with the choice to make their content red, yellow, or green. Each color of content has different properties.

Green content can be freely viewed by a user. It can be taken off of the server for free and used for any purpose without limitation. Typically this kind of content would be in the public domain.

Yellow content can be taken off of the server for free. It can be viewed by users for free; the owner may or may not be paid a royalty for this viewing, subject to negotiations with the owner of the content. It can be downloaded for free personal use, but is still someone else's protected work. This means that it can be used outside the server for personal use simply by the user agreeing to standard terms via a form agreement. Yellow may be the default for user-uploaded content, the public domain status of which may not have been reviewed. Special permission must be gained from the owner for commercial use.

Red content can be viewed and edited within the server subject to permission of the content owner. It may not be taken off the server unless the content owner has enabled this use. In the case where downloading is allowed the user must pay a fee to take the content off of the server. Red content owners can also receive royalties for the viewing of their material on the server.

A single individual or company is provided the ability to create videos and other media content and submit it to the server as green, yellow or red content. Once the content is approved, then the individual can begin receiving royalties for this content based on a contractual agreement.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, as set forth in the following claims.

What is claimed is:

1. A method for editing, organizing, and playing a digital presentation, the method comprising:
from a first location, previewing a plurality of streaming digital media objects stored at one or more locations remote from the first location;
for each of said plurality of streaming digital media objects, editing each of said plurality of streaming digital media objects at a selected remote location by:
identifying a first marker and a second marker corresponding to a starting point and an ending point for each said streaming digital media object;
generating an index of the edited streaming digital media objects and said first and second markers;
generating sequencing information for said edited streaming digital media objects; and
storing said index and said sequencing information in a remote database; and
upon receipt of a user command, assembling the edited streaming digital media objects into a combined streaming media presentation using said index and said sequencing information; and
downloading said combined streaming media presentation to a user computing device located at the first location.

2. The method of claim 1 further comprising defining a plurality of libraries from which said digital media objects may be selected.

3. The method of claim 2 wherein a set of user access rights are granted to a user, said user access rights defining which of said plurality of libraries may be accessed by said user.

4. The method of claim 1 further comprising for at least one of said plurality of streaming digital media objects, identifying a third marker and a fourth marker corresponding to a second starting point and a second ending point in said streaming digital media object.

5. The method of claim 1 further comprising assigning a designator to each of said streaming digital media objects associated with a degree of permissions required with respect thereto.

6. The method of claim 5 wherein said designator is selected from a set of three possible options.

7. The method of claim 6 wherein said three possible options comprise:
green content that can be freely viewed by a user, taken off of a server for free and used for any purpose without limitation;
yellow content that can be taken off of the server for free, viewed by users for free and used subject to negotiations with an owner of the yellow content; and
red content that can be viewed and edited within the server subject to permission of the red content owner, may not be taken off the server unless the content owner has permitted or may be downloaded for a fee.

8. The method of claim 1 wherein said streaming digital media objects comprise at least two different digital formats.

9. The method of claim 2 wherein said streaming digital media objects comprise at least two different digital formats.

10. The method of claim 1 in which the combined streaming media presentation is downloaded to a user computing device located not at the first location but at a second location.

11. The method of claim 1 in which the editing of the plurality of streaming digital media objects is performed at a selected remote location that is not one of the one or more locations remote from the first location.

12. The method of claim 1 in which the editing of the plurality of streaming digital media objects is performed at one of the one or more locations remote from the first location.

13. A system for editing and playing a digital presentation, the system comprising:
an application server at a first location, said application server running software for editing and playing a plurality of streaming digital media objects at one or more locations remote from the first location, wherein said application server is configured to edit each of said plurality of streaming digital media objects at the one or more locations remote from the first location by identifying a first marker and a second marker corresponding to a starting point and an ending point, respectively;
a first data library for storing at least some of said edited streaming digital media objects at the one or more locations remote from the first location;
a first remote client system configured to preview the plurality of the edited streaming digital media objects accessible to said application server;
a playlist comprising an index of said edited streaming digital media objects and sequencing information for said edited streaming digital media objects, the playlist located at a playlist location remote from the first location;
a database in communication with said application server for storing said playlist, the database located at a database location remote from the first location;
wherein said application server, upon receipt of a user command, assembles a combined streaming media presentation using said playlist and downloads said combined streaming media presentation to a user computing device located at the first location.

14. The system of claim 13 further comprising a second data library which, together with said first data library, is at least part of a first set of data libraries.

15. The system of claim 14 wherein said plurality of streaming digital media objects comprises at least one digital media object stored within said second data library.

16. The system of claim 13 further comprising a second application server, said second application server having access to a second set of data libraries.

17. The system of claim 16 wherein said second set of data libraries comprises said first data library.

18. The system of claim 16 wherein said second set of data libraries does not comprise said first data library.

19. The system of claim 16 wherein said first data library is accessible to said first application server and said second application server.

20. The system of claim 13 wherein said first data library comprises advertising content.

21. The system of claim 16 wherein said first data library comprises a plurality of advertising digital media objects, and wherein said plurality of advertising digital media objects are accessible to said first application server and said second application server.

22. The system of claim 13 in which the user computing device is located not at the first location but at a second location.

23. The system of claim 13 in which the application server is configured to edit each of the plurality of streaming digital media objects at a selected location that is neither one of the one or more locations remote from the first location nor is it the first location.

24. The system of claim 13 in which the application server is configured to edit each of the plurality of streaming digital media objects at one of the one or more locations remote from the first location.

25. The method of claim 1 further comprising:
reviewing reports about how long and which streaming digital media objects were viewed;
translating the reports to sponsors; and
receiving revenue from the sponsors to associate their message with actual and measured viewing activity of the streaming digital media objects.

26. The method of claim 25 further comprising:
paying royalties to the digital media object owner.
